(19) United States
(12) Patent Application Publication
(10) Pub. No.: US 2016/0094369 A1
(43) Pub. Date: Mar. 31, 2016

(54) Unidirectional Relay Device

(71) Applicant: Hitachi, Ltd., Tokyo (JP)

(72) Inventors: Tran Ngoc CHUYEN, Tokyo (JP); Yoshihiro NAKANO, Tokyo (JP); Takuma NISHIMURA, Tokyo (JP); Hidemasa NAKAI, Tokyo (JP); Masahiro EGUCHI, Tokyo (JP); Yuuichi FUSE, Tokyo (JP); Tatsuya TSUMURAYA, Tokyo (JP); Shinichi HANADA, Tokyo (JP); Shuuichi OKAZAKI, Tokyo (JP)

(21) Appl. No.: 14/856,856

(22) Filed: Sep. 17, 2015

(30) Foreign Application Priority Data
Sep. 29, 2014 (JP) 2014-197755

(51) Int. Cl. H04L 25/22; H04L 12/741

(52) U.S. Cl. CPC H04L 25/22; H04L 45/74

(57) ABSTRACT

A unidirectional relay device includes a first port that receives communication data from one network, a first physical layer circuit that performs a protocol process of a physical layer, a first MAC layer circuit that performs a protocol process of a MAC layer, a second MAC layer circuit that is connected to the first MAC layer circuit through a signal line to perform a protocol process of a MAC layer, a second physical layer circuit that performs a protocol process of a physical layer, and a second port that transmits communication data to the other network. The signal line is a signal line that transmits data unidirectionally to the second MAC layer circuit from the first MAC layer circuit, and a signal line for transmitting data from the second MAC layer circuit to the first MAC layer circuit is opened or is connected to a ground.

### TECHNICAL FIELD

The present invention relates to a unidirectional relay device that allows data to travel, only in one direction.

### BACKGROUND ART

As the related art, for example, in PTL 1, it is an object thereof to obtain “a simplex communication device configured such that only simplex data transmission is performed and an intrusion in a reverse direction is prevented” (see the Abstract), and in order to achieve such an object, it is described that “the simplex communication device includes a first component configured to perform only simplex data communication for transmitting data received from a data transmission source by an asynchronous protocol, and a second component configured to perform only simplex data communication for transmitting data received from the first component by an asynchronous protocol to a data transmission destination, in which the first component receives data transmitted from the data transmission source via a first network through IP communication, and the second component receives data from the first component by an asynchronous protocol” (see claim 1).

In PTL 2, it is an object thereof to “provide a data communication system having higher safety against an attack on a computer”, and in order to achieve such an object, it is described that “the data communication system includes a first computer 1 including a data transmission processing unit 110, a second computer 2 including a data reception processing unit 20, and a communication line 3 that connects the first computer 1 and the second computer 2, in which the communication line 3 performs unidirectional communication by excluding a signal line for transmitting data from the second computer 2 to the first computer 1. Thus, an attack from the outside on the first computer 1 is prevented” (see the Abstract).

### CITATION LIST

### Patent Literature

[PTL 1] JP-A-2004-185483
[PTL 2] JP-A-2010-199943

### SUMMARY OF INVENTION

### Technical Problem

As stated above, in PTL 1, a logical prevention mechanism is adopted in order to prevent the intrusion in the reverse direction. That is, by writing a filter program in a ROM, only single-directional data transmission is performed on a specific IP address or MAC address whose setting is difficult to be changed by using an upper-layer filter program, and thus, the attack in the reverse direction is prevented.

However, in the technology described in PTL 1, even when a logical unidirectional communication from an internal system to an external system is done, a communication line is actually in a state were duplex communication can be physically performed. For this reason, the duplex communication may be performed by manipulating the filter program, and as a result, an attack such as an illegal intrusion via a network may be carried out.

In PTL 2, a physical prevention mechanism is adopted. That is, the unidirectional communication is realized by excluding the signal line for transmitting data from the external system to the internal system, and an external attack on the internal system is prevented.

However, in the technology described in PTL 2, since a communication path from the external system to the internal system is not physically present, the attack such as the illegal intrusion on the internal system by manipulating the filter program may be excluded may be excluded. However, since the signal line for transmitting the data to the internal system is excluded from the communication line, it is difficult to establish a duplex link, in the communication line through autonegotiation.

The invention has been made in order to solve such problems, and it is an object of the invention to prevent an illegal intrusion from an external system and to safely provide data of an internal system to the external system.

### Solution to Problem

To solve the problem described above, the invention provides a unidirectional relay device including: a first port that receives communication data from one network, a first physical layer circuit that is connected to the first port through a first signal line to perform a protocol process of a physical layer, a first MAC layer circuit that is connected to the first physical layer circuit through a second signal line to perform a protocol process of a MAC layer, a second MAC layer circuit that is connected to the first MAC layer circuit through a third signal line to perform a protocol process of a MAC layer, a second physical layer circuit that is connected to the second MAC layer circuit through a fourth signal line to perform a protocol process of a physical layer, and a second port that is connected to the second physical layer circuit through a fifth signal line to transmit communication data to the other network, wherein the third signal line is a signal line that transmits data in one direction to the second MAC layer circuit from the first MAC layer circuit, and a signal line for transmitting data from she second MAC layer circuit to the first. MAC layer circuit is opened or is connected to a ground.

### Advantageous Effects of Invention

According to the invention, it is possible to prevent an illegal intrusion from an external system and to safely provide data of an internal system to the external, system.

### BRIEF DESCRIPTION OF DRAWINGS

FIG. 1 is a configuration diagram of the invention.

FIG. 2 is a block diagram showing GMII for achieving unidirectional relay.

FIG. 3 is a block diagram showing control such that a frame is transmitted to the outside.

FIG. 4 is a block diagram showing a state where a frame is prevented from being transmitted to the inside.

FIG. 5 is a block diagram showing a unicast communication method in which a load is reduced.

### DESCRIPTION OF EMBODIMENTS

Hereinafter, embodiments will be described with reference to the drawings.

### Embodiment 1

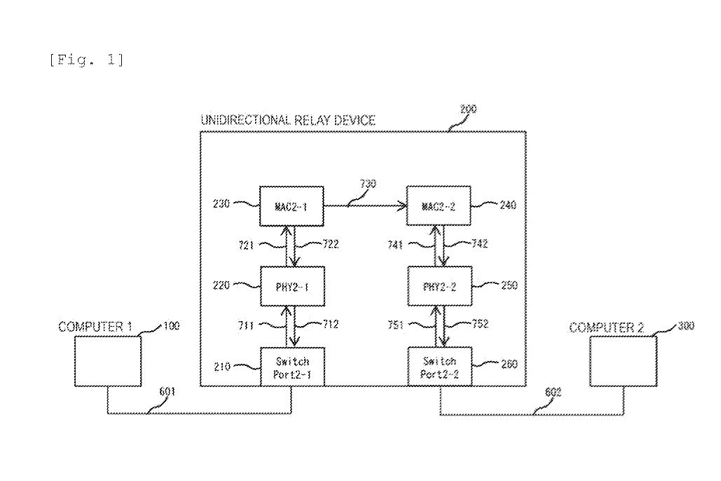

FIG. 1 is a block diagram of Embodiment. 1 showing an embodiment of the invention. A configuration in which data retained in a computer 1 (100) is transmitted to a computer 2 (300) via a unidirectional relay device in a single direction is illustrated. The computer 1 (100) and a unidirectional relay device (200) are connected through a communication line (601). The unidirectional relay device (200) and the computer 2 (300) are connected through a communication line (602). The unidirectional relay device 200 includes a SwitchPort 2-1 (210), a PHY 2-1 (220), a MAC 2-1 (230), a MAC 2-2 (240), a PHY 2-2 (250), and a SwitchPort 2-2 (260).

MAC refers to an IC that processes a protocol of a media access control (MAC) layer. PHY is an IC that processes a protocol of a physical layer. SwitchPort is a port that is connected to a UTP cable of a category 5 or 5e.

The SwitchPort 2-1 (210) and the PHY 2-1 (220) are connected through signal lines (711) and (712), and the PHY 2-1 (220) and the MAC 2-1 (230) are connected through signal lines (721) and (722). The transmission-side MAC 2-1 (230) and the reception-side MAC 2-2 (240) are connected through a unidirectional communication signal line group (730) of a parallel interface GMII (Gigabit Media Independent Interface). The MAC 2-2 (240) and the PHY 2-2 (250) are connected through signal lines (741) and (742), and the PHY 2-2 (250) and the Switchport 2-2 (260) are connected through signal lines (751) and (752).

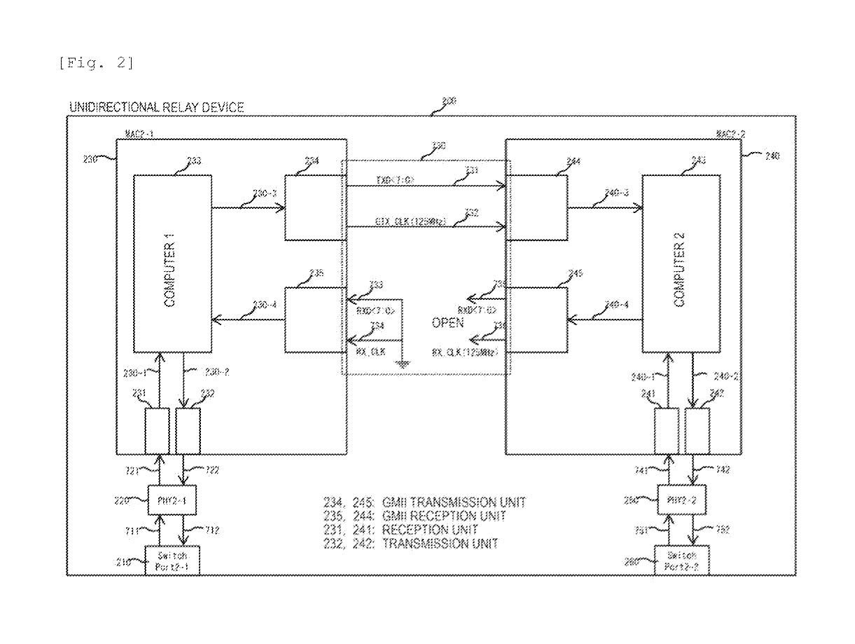

Next, FIG. 2 is a block diagram showing the details of the inside of the unidirectional relay device shown in FIG. 1, specifically, the MAC layer. The MAC 2-1 (230) communicates with the PHY 2-1 (220) through a reception unit (231) and a transmission unit (232). The MAC 2-2 (240) communicates with the PHY 2-2 (250) through a reception unit (241) and a transmission unit (242). The MAC 2-1 (230) is connected to the MAC 2-2 (240) through the signal line group (730) of the parallel interface GMII.

In the invention, the signal line group (730) of the parallel interface GMII of FIG. 2 is physically used for only unidirectional communication. The signal group (730) of the parallel interface conformable so general IEEE 802.3z performs duplex communication by providing two groups of a transmission signal group and a reception signal group.

The signal group (730) is configured such that a transmission signal group including a transmission timing signal GTX_CLK (732) and 8 data lines TXD<7:0> (731) transmission frames are connected and a reception signal group including reception timing signals RX_CLK (734) and (736), 8 data lines RXD<7:0> (733) and (735) for reception frames are disconnected.

A connection configuration for achieving unidirectional relay will be described below. The reception timing signal (734) and the 8 data lines RXD<7:0> (733) for reception frames in the MAC 2-1 (230) which is a transmission side are pulled down, that is, are connected to a ground (GND). Since a voltage of a digital circuit is maintained through the pulling-down, it is possible to prevent a malfunction.

The reception timing signal RX_CLK (736) and the 8 data lines RXD:7:0> (735) for reception frames in she MAC 2-2 (240) at reception side are opened (internally pulled down). Thus, since a communication path from the MAC 2-2 (240) to the MAC 2-1 (230) is not present, it is impossible to physically perform data transmission in this direction.

A control unit 1 (233) determines whether data which is received by the reception unit (231) after passing from the SwitchPort 2-1 (210) to the PHY 2-1 (220) is relayed or discarded. Relay data is relayed to a CMII reception unit (244) via the 8 data lines TXD<7:0> (731) for transmission frames by a CMII transmission unit (234). A clock of 125 MHz is supplied to the CMII reception unit (244) from the CMII transmission unit (234). The data is transmitted to the PHY 2-2 (250) and the SwitchPort 2-2 (260) via a control unit 2 (243) and the transmission unit (242). In contrast, the data received by the reception unit (241) from the SwitchPort 2-2 (260) and the PHY 2-2 (250) is transmitted to a CMII transmission unit (245) via the control unit 2 (243). However, since the data lines RXD<7:0> (735) and the timing signal RX_CLK (736) are opened, the data is not transmitted to a CMII reception unit (235).

In such a configuration, only single-directional communication from the computer 1 (100) to the computer 2 (300) can be performed.

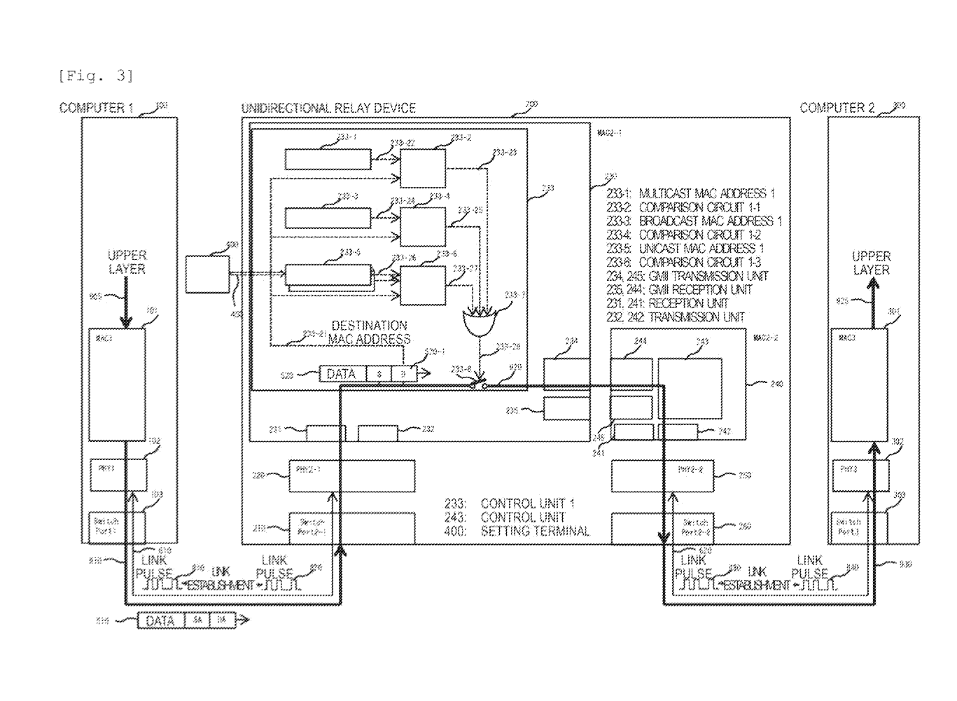

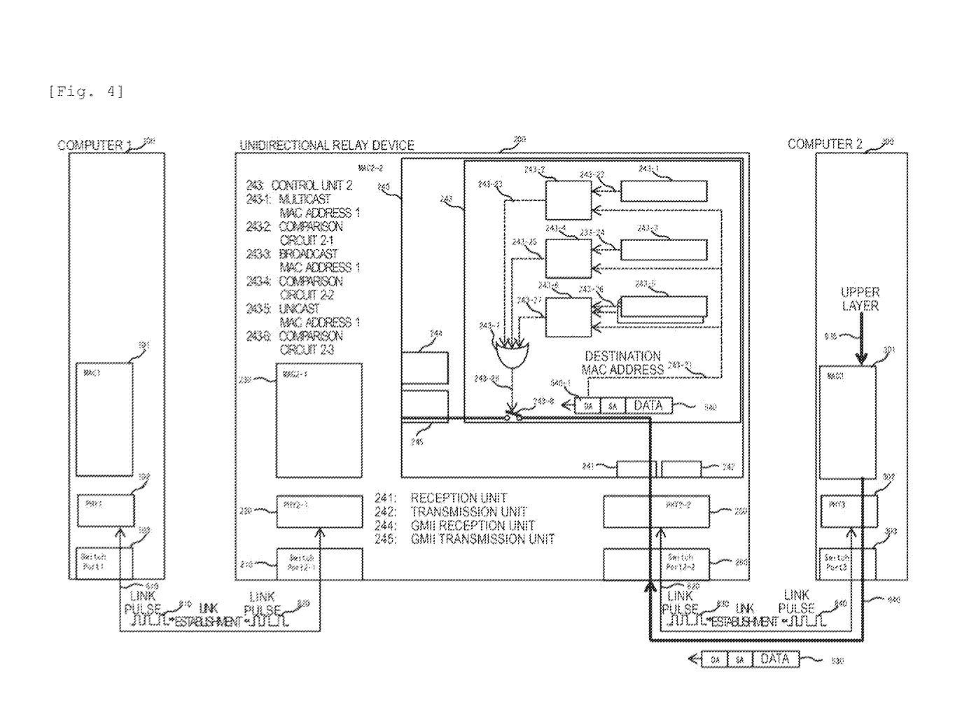

Next, a communication method of unidirectional relay according to the present embodiment will be illustrated in FIGS. 3 and 4.

FIG. 3 is a block diagram showing the configuration of communication from the computer 1 (100) to the computer 2 (300) Firstly, a communication link between the computer 1 (100) and the unidirectional relay device (200) is established through autonegotiation between the PHY 1 (102) and the PHY 2-1 (220) (610). Autonegotiation is generally defined by IEEE 802.3u and is a function allowing an interface of each device so automatically set the most appropriate speed and mode from the choices of communication speeds and communication modes between the device and the corresponding device. Thus, a link between the computer 1 (100) and the unidirectional relay device (200) is established by outputting link pulses (810) and (820) and mutually performing a handshake.

Similarly, a communication link between the unidirectional relay device (200) and the computer 2 (300) is established through an autonegotiation operation between the PHY 2-2 (250) and a PHY 3 (302) using link, pulses (830) and (840), or by outputting the link pulses (830) and (840) between the PHY 2-2 (250) and the PHY 3 (302) and mutually performing a handshake (620).

Subsequently, the computer 1 (100) transmits data to the MAC 1 (101) from an upper layer (905). The MAC 1 (101) transmits she data as a frame conformable to general IEEE 802.3 (910), and it is determined whether or not the data is relayed to the computer 2 (300) or is discarded by checking a destination MAC address DA (520-1) of a frame (520) by the control unit 1 (233) of the MAC 2-1 (230) of the unidirectional relay device (200). The general frame includes the destination MAC address DA (520-1), a transmission source MAC address SA, and data.

Bits (23-21) of the destination MAC address CA (520-1) of the frame (520) are compared to bits (233-22) of a multi cast MAC address 1 (233-1) with a comparison circuit 1-1 (233-2), are compared to bits (233-24) of a broadcast MAC address 1 (233-3) with a comparison circuit 1-2 (233-4), and are compared to bits (233-26) of a unicast MAC address 1 (233-5) with a comparison circuit 1-3 (233-6). The multicast MAC address 1 (233-1), the broadcast MAC address 1 (233-3) and the unicast MAC address 1 (233-5) are registered in a register.

Here, a predetermined address is registered in the unicast MAC address 1 (233-5) in association with the computer (300) that is connected to the outside from an external setting terminal (400) (450).

In the comparison circuit 1 (233-2), the comparison circuit 2 (233-4) and the comparison circuit 3 (233-6), if two input values are she same, the output is 1, and if the two input values are different, the output is 0.

An OR is performed on the comparison results (233-23), (238-25) and (233-27) (233-7). If the output (233-28) of the OR is 1, the frame (520) is relayed, and if the output thereof is 0, this frame is discarded. When the frame (520) is relayed, this frame is relayed to a MAC 3 (301) of the computer 2 (300) from the GMII transmission unit (234) of the MAC 2-1 (230) via the MAC 2-2 (240), the PHY 2-2 (250), and the SwitchPort 2-2 (260) (930). Thereafter, the MAC 3 (301) transmits the frame to the upper layer (925).

As mentioned above, a broadcast frame, a multicast frame, and only a unicast in which the destination MAC address is registered are relayed by checking the destination MAC address (520-1) of the frame (520). Thus, it is possible to prevent a unicast frame with unknown destination from being relayed.

FIG. 4 is a block diagram showing the configuration in which communication from the computer 2 (300) to Me computer 1 (100) is prevented. The computer 2 (300) transmits data to the MAC 3 (301) from the upper layer (935) The MAC 3 (301) transmits the data as a frame (530) (940). In the control unit 2 (243) of the MAC 2-2 (250) of the unidirectional relay device (200), it is determined whether or not this frame is relayed or discarded similarly to the control unit 1 (233) of the MAC 2-1 (230). When it is determined that the frame is relayed, the frame is relayed, to the GMII transmission unit (245). However, since the signal line having the communication direction to the MAC 2-1 (230) is not physically connected, it is impossible to relay the frame to the MAC 2-1 (230). Accordingly, the frame does not physically arrive at the computer 1 (100).

As stated above, in the present embodiment, by connecting only in a one direction the signal line of the physical wiring (GMII) of a data link layer (layer 2) that is not aware of link establishment, even if a condition such as filtering is manipulated, since there is no frame invasion path from the outside, it is possible to safely perform only single-directional communication. In the present embodiment, since duplex connection is performed up to the physical layer, it is possible to realize only single-directional frame relay without obstructing the process for link establishment.

Thus, the data communication from the internal system to the external system is defined in the single direction, and thus, it is possible to provide the unidirectional relay device that prevents an illegal intrusion from an external network. Since a physical communication path is not present in the unidirectional relay device, illegal access from the outside is cut-off. Thus, it is possible to prevent almost 100% of illegal access to an important system.

### Embodiment 2

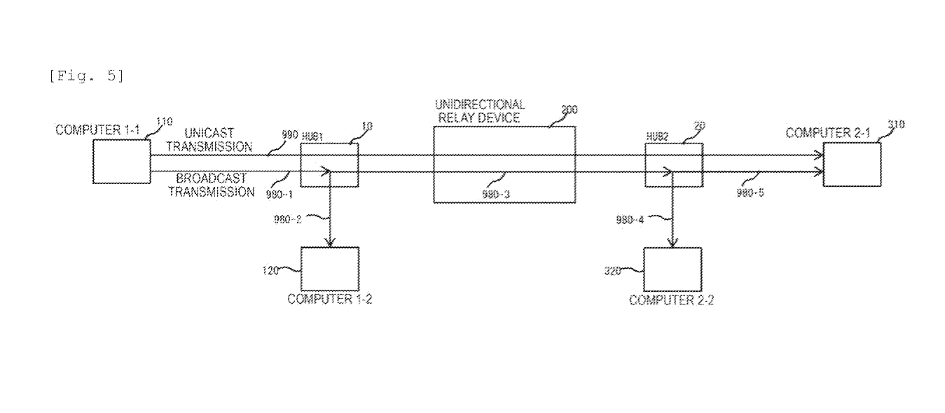

A communication method for reducing a load to a network will be described as Embodiment 2 of the invention with reference to FIG. 5. In general, when only communication from a computer 1-1 (210) or a computer 1-2 (120) which is an internal system to a computer 2-1 (310) or a computer 2-2 (320) which is an external system is allowed, a unidirectional relay device (200) is used by being combined with a HUB 1 (10) and a HUB 2 (20).

As an example, a frame being transmitted to the external system from the computer 1-1 (110) may be considered. When the destination is not specified, the broadcast frame is generally transmitted (990) In such a communication direction, the frame arrives at all devices of the internal system and the external system other than the computer 1-1 (110).

However, when the destination is specified, since an unnecessary load is applied to the devices other than the destination computer in the broadcast transmission method, the unicast transmission with specified destinations is considered. Such communication is performed by registering the MAC address of the targeted computer in a unicast MAC address 1 (233-5) of the unidirectional relay device. By this method, it is possible to relay only a necessary frame, and thus, it is possible to reduce a load applied to the devices other than the destination computer.

As described above, it is possible to transmit the data from the computer 1 to the computer 2. However, since it is impossible to physically perform communication from the computer 2 to the computes 1, it is possible to prevent an attack such as an illegal intrusion from the computer 2.

Since the destination computer is specified, it is possible to reduce an unnecessary load applied to the internal system and the external system by transmitting the unicast frame.

The present invention not limited to the aforementioned embodiments, and includes various modifications. For example, the aforementioned embodiments are described in detail to easily understand the present invention, and are not limited to necessarily have all the described configurations. A part of the configuration of a certain embodiment can be replaced with the configuration of another embodiment, and the configuration of another embodiment can be added to the configuration of a certain embodiment. Another configuration can be added to, removed from, or replaced with a part of the configurations of the respective embodiments.

### REFERENCE SIGNS LIST

10: Relay device HUB 1
20: Relay device HUB 2
100: Computer 1
101: MAC 1
102: PHY 1
103: SwitchPort 1
110: Computer 1-1
120: Computer 1-2
200: Unidirectional relay device
210: SwitchPort 2-1
220: PHY 2-1
230: MAC 2-1
230-1: Signal line from reception unit to control unit 1
230-2: Signal line from control unit 1 to transmission unit
230-3: Signal line from control unit 1 to GMII transmission unit
230-4: Signal line from GMII reception unit to control unit 1
231: Reception unit
232: Transmission unit
233: Control unit 1
233-1: Multicast MAC address 1
233-2: Comparison circuit 1-1
233-3: Broadcast MAC address 1
233-4: Comparison circuit 1-2
233-5: Unicast MAC address 1
233-6: Comparison circuit 1-3
233-7: OR circuit
233-21: Bits of destination MAC address CA of frame
233-22: Bits of multicast MAC address 1
233-23: Result of comparison circuit 1-1
233-24: Bits of broadcast MAC address 1
233-25: Result of comparison circuit 1-2
233-26: Bits of unicast MAC address 1
233-27: Result of comparison circuit 1-3
233-28: Output of OR circuit
234: GMII transmission unit
235: GMII reception unit
240: MAC 2-2
240-1: Signal line from reception unit to control unit 2
240-2: Signal line from control unit 2 to transmission unit
240-3: Signal line from control unit 2 to GMII transmission unit
240-4: Signal line from GMII reception unit to control unit 2
241: Reception unit
242: Transmission unit
243: Control unit 2
243-1: Multicast MAC address 2
243-2: Comparison circuit 2-1
243-3: Broadcast MAC address 2
243-4: Comparison circuit 2-2
243-5: Unicast MAC address 2
243-6: Comparison circuit 2-3
243-7: OR circuit
243-21: Bits of destination MAC address DA of frame
243-22: Bits of multicast MAC address 1
243-23: Result of comparison circuit 2-1
243-24: Bits of broadcast MAC address 1
243-25: Result of comparison circuit 2-2
243-26: Bits of unicast MAC address 1
243-27: Result of comparison circuit 2-3
243-28: Output of OR circuit
244: GMII transmission unit
245: GMII reception unit
250: PHY 2-2
260: SwitchPort 2-2
300: Computer 2
301: MAC 3
302: PHY 3
303: SwitchPort 3
310: Computer 2-1
320: Computer 2-2
400: Setting terminal
450: Registering unicast MAC address
510: Frame transmitted from computer 1
520: Frame which is transmitted from computer 1 and is processed within unidirectional relay device
520-1: Destination MAC address of frame which is transmitted from computer 1 and is processed within unidirectional relay device
530: Frame transmitted from computer 2
540: Frame which is transmitted from computer 2 and is processed within unidirectional device
540-1: Destination MAC address of frame which is transmitted from computer 2 and is processed within unidirectional relay device
601: Communication line between computer 1 and unidirectional relay device
602: Communication line between unidirectional relay device and computer 2
610: Negotiation between computer 1 and unidirectional relay device
620: Negotiation between unidirectional relay device and computer 2
711: Communication signal line from SwitchPort 2-1 to PHY 2-1
712: Communication signal line from PHY 2-1 to SwitchPort 2-1
721: Communication signal line from PHI 2-1 to MAC 2-1
722: Communication signal line from MAC 2-1 to PHY 2-1
730: Signal line group of parallel interface CMII
731: 8 data lines TXD<7:0> of transmission frame
732: Transmission timing signal GTX_CLK
733: 8 data lines RXD<7:0> of reception frame in MAC
734: Reception timing signal RX_CLK in MAC 2-1
735: 8 data lines RXD<7:0> of reception frame in MAC 2-2
736: Reception timing signal RX_CLK in MAC 2-2
741: Communication signal line from PHY 2-2 to MAC 2-2
742: Communication signal line from MAC 2-2 to PHI 2-2
751: Communication signal line from SwitchPort 2-2 to PHY 2-2
752: Communication signal line from PHY 2-2 to SwitchPort 2-2
810: Link pulse output from computer 1
820: Link pulse output from unidirectional relay device to computer 1
830: Link pulse output from unidirectional relay device to computer 2
840: Link pulse output from computer 2
905: Data transmission from upper layer to MAC
910: Transmitting frame from MAC 1 of computer 1 to unidirectional relay device
920: Relaying frame within unidirectional relay device
925: Data transmission from MAC 3 to upper layer
930: Transmitting frame to MAC 3 of computer 2 from unidirectional relay device
935: Data transmission from upper layer to MAC 3
940: Transmitting frame from MAC 3 of computer 2 to unidirectional relay device
950: Discarding frame within unidirectional relay device
980-1 Broadcast transmission from computer 1-1 to HUB 1
980-2: Broadcast transmission from HUB 1 to computer 1-2
980-3: Broadcast transmission via unidirectional relay device
980-4: Broadcast transmission from HUB 2 to computer 2-2
980-5: Broadcast transmission from HUB 2 to computer 2-1
990: Unicast transmission from computer 1-1 to computer 2-1 via unidirectional relay device

1. A unidirectional relay device comprising:
a first port that receives communication data from one network;
a first physical layer circuit that is connected to the first port through a first signal line to perform a protocol process of a physical layer;
a first MAC layer circuit that is connected to the first physical layer circuit through a second signal line to perform a protocol process of a MAC layer;
a second MAC layer circuit that is connected to the first MAC layer circuit through a third signal line to perform a protocol process of a MAC layer;
a second physical layer circuit that is connected to the second MAC layer circuit through a fourth signal line to perform a protocol process of a physical layer; and
a second port that is connected to the second physical layer circuit through a fifth signal line to transmit communication data to the other network,
wherein the third signal line is a signal line chat transmits data in unidirectional to the second MAC layer circuit from the first MAC layer circuit, and a signal line for transmitting data from the second MAC layer circuit to the first MAC layer circuit is opened or is connected to a ground.

2. The unidirectional relay device according to claim 1,
wherein when another communication device is connected so the first port, a link is established by transmitting and receiving a link pulse between a physical layer circuit within the other communication device and the first physical layer circuit, and
when another communication device is connected to the second port, a link is established by transmitting and receiving a link pulse between a physical layer circuit within the other communication device and the second physical layer circuit.

3. The unidirectional relay device according to claim 1,
wherein the first MAC layer circuit includes a control unit in which a MAC address of a frame to be relayed from the one network to the other network is stored, and
the control unit compares whether or not a destination MAC address within a frame of communication data received from the first physical layer circuit is the MAC address stored in the control unit, transmits the communication data to the second MAC liver circuit when the destination MAC address is the stored MAC address, and discards the communication data when the destination MAC address is not the stored MAC address.

4. The unidirectional relay device according to claim 3,
wherein the MAC address stored in the control unit includes at least a multicast MAC address, a broadcast MAC address, and a unicast MAC address, and the communication data is discarded when the destination MAC address within the frame of the communication data received by the first physical layer circuit does not coincide with any of the MAC addresses.
